(19) United States
(12) Patent Application Publication
(10) Pub. No.: US 2006/0050297 A1
(43) Pub. Date: Mar. 9, 2006

(54) Data control device, method for controlling the same, image output device, and computer program product

(75) Inventors: Takeshi Morikawa, Takarazuka-shi (JP); Nobuhiro Mishima, Osaka-shi (JP); Takeshi Minami, Amagasaki-shi (JP); Okihisa Yoshida, Amagasaki-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/006,612

(22) Filed: Dec. 8, 2004

(30) Foreign Application Priority Data
Sep. 8, 2004 (JP) 2004-261174

(51) Int. Cl. G06F 3/12

(52) U.S. Cl. 358/1.15

(57) ABSTRACT

An image forming device includes a data memory portion for storing files, a printer device for printing images and a communication interface for sending image data. The image forming device further includes a user discrimination portion for discriminating a user who operates the image forming device, a related file extraction portion for searching and extracting files having connection with the discriminated user, a display device for displaying a data list screen for the user to select files to be processed from the extracted files, and a process execution control portion for controlling the printer device, the communication interface or the hard disk drive so as to execute a predetermined process in accordance with the file selected by the user.

This application is based on Japanese Patent Application No. 2004-261174 filed on Sep. 8, 2004, the contents of which are hereby incorporated by reference.

### BACKGROUND OF THE INVENTION

1. Field of the Invention

The present invention relates to a method for handling data stored in a hard disk drive or the like. More specifically, the present invention relates to a method for handling image data that are used in an image output device such as an MFP.

2. Description of the Prior Art

Recently, an image forming device called a multifunction device or a multi function peripheral (MFP) has been used widely, which has functions of a copy machine, a scanner, a fax machine, a network printer and a document server. According to a function of a document server, a storage area called a “personal box” or a “box” can be provided for each user. Each user can store various data in his or her box. For example, the user can store image data of an image to be printed by the image forming device or image data to be sent from the image forming device to another device.

In addition, as a method for managing job data in a device such as an image forming device, some methods are proposed as described in the following documents. Japanese unexamined patent publication No. 2003-150336 teaches a method in which a list of jobs in a pending state for execution is obtained in an MFP when a user logs in the MFP by user information entered from a console. Among the list, jobs having user identification information that is identical to the user information that was used for the log-in are displayed as a list on the console. Then, the MFP performs a job included in the list display on the console in accordance with a job execution instruction made by the user.

Japanese unexamined patent publication No. 10-312251 teaches a method in which a digital copying machine receives a print job from a client computer that is connected to a network via a printer server computer. Print jobs are stored in a storage portion of the digital copying machine or the printer server and managed by a job management table of the storage portion. When an operator does an operation for rewriting the job management table by using an operation panel or the like, the digital copying machine changes or adds a print mode in accordance with the operation.

Japanese unexamined patent publication No. 2003-280843 teaches a method in which a print order control module that constitutes a print server searches each print job in a document queue in accordance with a “sort extraction condition” set in a condition storage table freely so that information satisfying the extraction condition is extracted from the print data of each print job. Furthermore, the print order of plural print jobs is changed in accordance with each of the extracted information as a key, plural print jobs are printed sequentially on a job-by-job basis in accordance with the print order.

However, according to the conventional method for managing job data as described in each of the above documents, every time when one job is selected for performing a certain process for the job data, the user has to give an instruction about the process contents. Therefore, if it is necessary to perform a process for many job data, the operation will be very burdensome procedure.

Furthermore, though a method for erasing all job data stored in a hard disk drive or the like of the image forming device is known, there is a risk that data necessary for other user are also erased by the method. Therefore, the method is not so practical.

### SUMMARY OF THE INVENTION

An object of the present invention is to prevent a user from affecting other user's data badly while the user can select plural data to be processed for performing the process readily.

A data control device according to the present invention includes a data storage portion for storing data, a data connection processing portion for performing a data connection process that is a process having connection with the data, a user discrimination portion for discriminating a user who operates the data control device, a data searching portion for searching the data having connection with the user discriminated by the user discrimination portion from the data stored in the data storage portion, and a screen output portion for producing a data list screen for the user to select any one to be an object of the data connection process among the searched data having connection with the user. The data connection processing portion performs the data connection process for the plural data selected by the user on the data list screen.

The data control device can be applied to an image output device including a print portion for printing an image on a recording sheet or a data transmission portion or the like for sending image data to other device. In this case, the image output device is structured as follows, for example. It includes a data storage portion for storing output data including image data of an image to be produced by the output portion, a user discrimination portion for discriminating a user who operates the image output device, a data searching portion for searching the output data having connection with the user discriminated by the user discrimination portion from data stored in the data storage portion, a screen output portion for producing the data list screen for the user to select output data to be processed among the searched output data having connection with the user and a process designation screen for the user to designate a process to be performed for the output data selected by the user, and a control portion for controlling each portion that constitutes the image output device so that a process designated by the user on the process designation screen is performed for the plural output data selected by the user on the data list screen.

According to the present invention, it is possible to prevent a user from affecting other user's data badly while the user can select plural data to be processed for performing the process readily.

### BRIEF DESCRIPTION OF THE DRAWINGS

FIG. 1 shows an example of an overall structure of a file sharing system.

FIGS. 2(a) and 2(b) show examples of an external view and a hardware structure of an image forming device according to the present invention respectively.

FIG. 3 shows an example of a box provided to a hard disk drive.

FIG. 4 shows an example of a structure of a file.

FIG. 5 shows an example of a user information database.

FIG. 6 shows an example of a job history database.

FIG. 7 shows an example of a functional structure of the image forming device.

FIG. 8 shows an example of an active job database.

FIG. 9 shows an example of an initial menu screen.

FIG. 10 is a flowchart showing an example of a flow of a general process of the image forming device.

FIG. 11 is a flowchart showing an example of a flow of a process for designating a box or the like.

FIG. 12 shows an example of a user selection screen.

FIG. 13 shows an example of a password input screen.

FIG. 14 shows an example of a file name input screen.

FIG. 15 shows an example of a user selection screen.

FIG. 16 shows an example of a password input screen.

FIG. 17 shows an example of a file name input screen.

FIG. 18 is a flowchart showing an example of a flow of a job operation process.

FIG. 19 shows an example of a process object selection screen.

FIGS. 20 and 21 are flowcharts showing an example of a flow of a process for accepting a job or the like.

FIG. 22 shows an example of a change designation screen.

FIG. 23 shows an example of a job list screen.

### DESCRIPTION OF THE PREFERRED EMBODIMENTS

Hereinafter, the present invention will be explained in more detail with reference to embodiments and drawings.

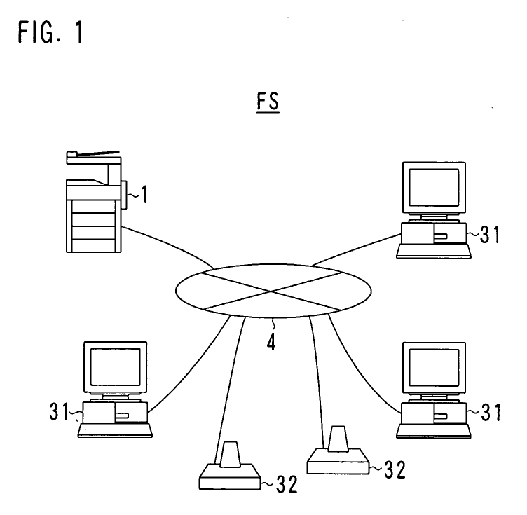

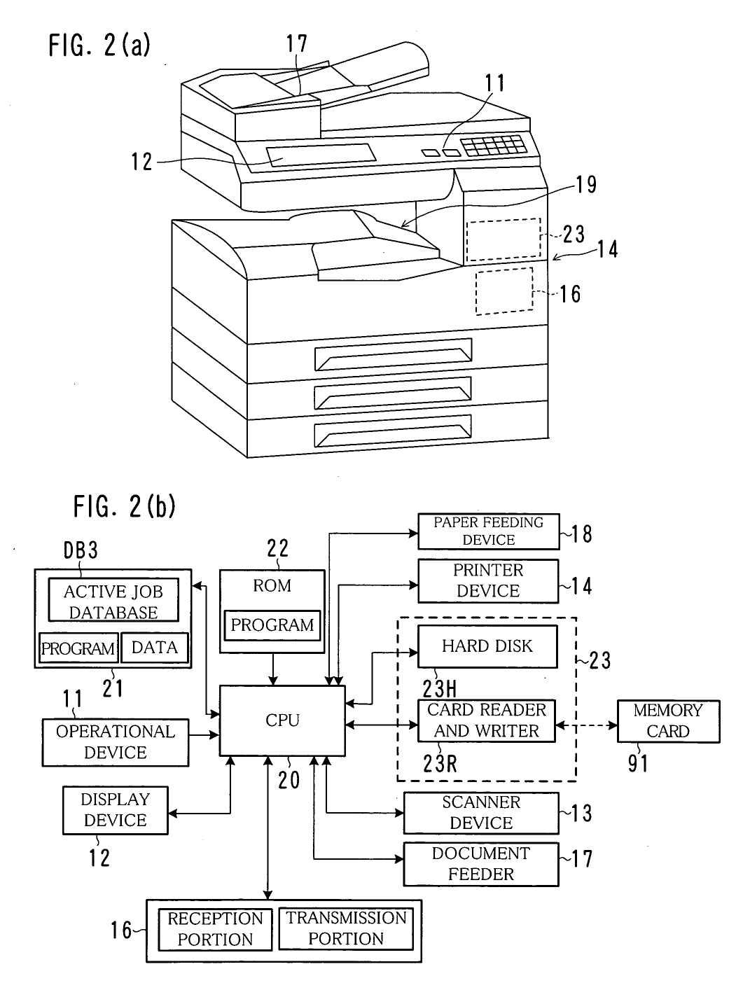

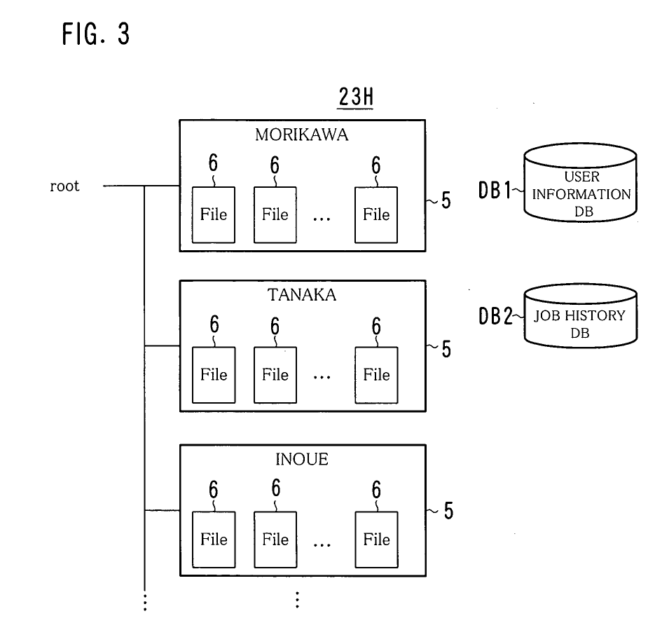

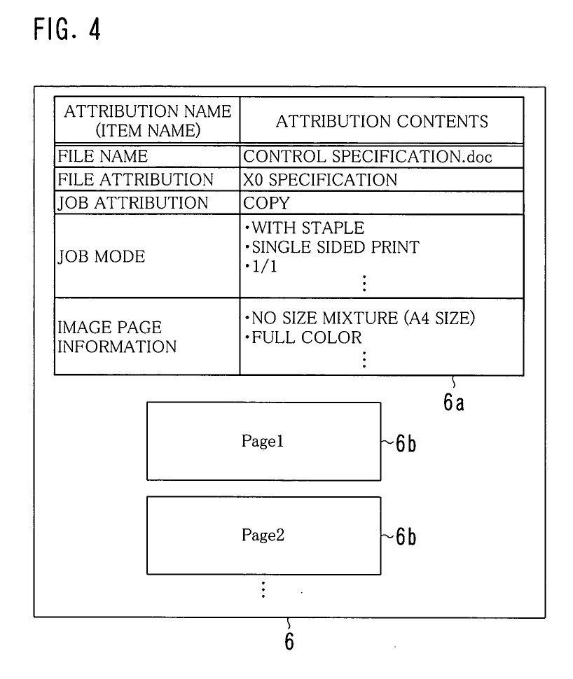

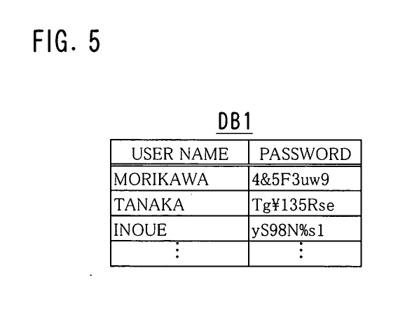

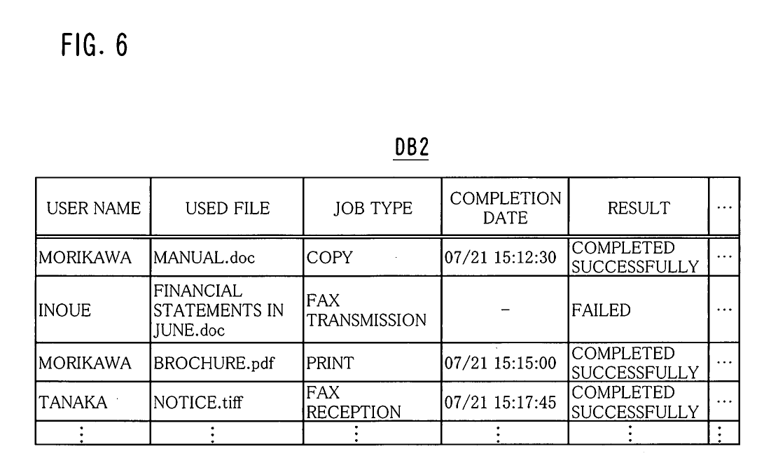

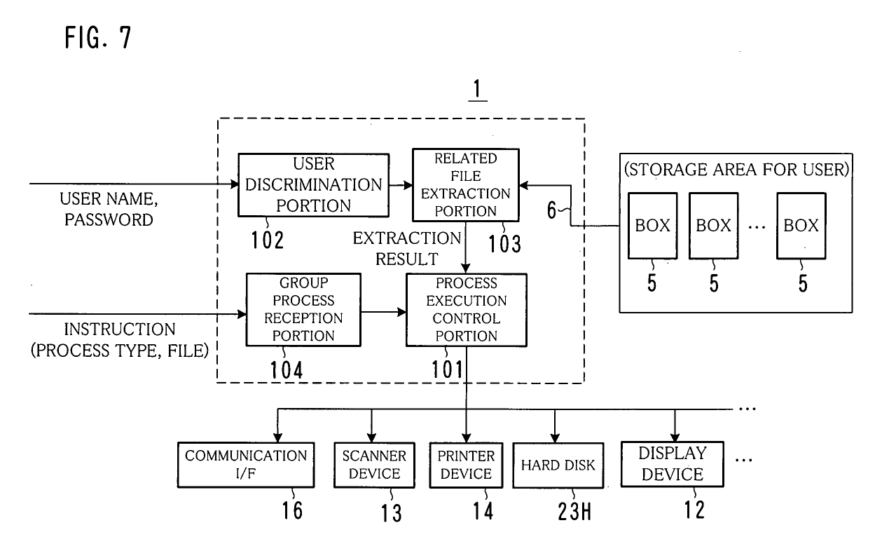

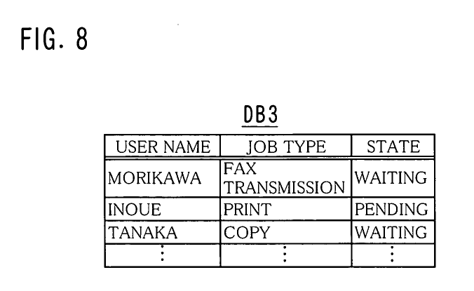

FIG. 1 shows an example of an overall structure of a file sharing system FS, FIGS. 2(a) and 2(b) show examples of an external view and a hardware structure of an image forming device 1 according to the present invention respectively, FIG. 3 shows an example of a box 5 provided to a hard disk drive 23H, FIG. 4 shows an example of a structure of a file 6, FIG. 5 shows an example of a user information database DB1, FIG. 6 shows an example of a job history database DB2, FIG. 7 shows an example of a functional structure of the image forming device 1, FIG. 8 shows an example of a active job database DB3.

As shown in FIG. 1, the file sharing system FS includes the image forming device 1 of the present invention, one or more personal computers 31, one or more FAX terminals 32 and a communication line 4. The image forming device 1 and each of the personal computers 31 are given identification information such as an IP address for identifying each of them. Each of the FAX terminals 32 is given a telephone number of a so-called fixed telephone or an IP telephone.

The image forming device 1, each of the personal computers 31 and each of the FAX terminals 32 can be connected to one another via the communication line 4. As the communication line 4, a LAN, the Internet, a private line or a public telephone line can be used. As a communication protocol or a communication standard, TCP/IP (Transmission Control Protocol/Internet Protocol), FTP (File Transfer Protocol), POP3 (Post Office Protocol version 3), SMTP (Simple Mail Transfer Protocol), IPP (Internet Printing Protocol), IEEE802.3 for a wired LAN, IEEE802.11 for a wireless LAN, G3 (Group 3) standard or G4 (Group 4) standard for FAX, or the like can be used.

According to this file sharing system FS, a user can share data stored in a hard disk drive of the image forming device 1 between the image forming device 1 and the personal computer 31. Instead of the personal computer 31, a workstation, a PDA (Personal Digital Assistant), a cellular phone or the like can be used.

The image forming device 1 is a device in which a copy, a network printing, a scanner, a FAX, a document server and other functions are integrated. It is also called a multifunction device or an MFP (Multi Function Peripheral).

This image forming device 1 includes a operational device 11, a display device 12, a scanner device 13, a printer device 14, a communication interface 16, a document feeder 17, a paper feeding device 18, a tray 19, a CPU 20, a RAM 21, a ROM 22 and a data memory portion 23 as shown in the external view of FIG. 2(a) and in the hardware structure of FIG. 2(b).

The operational device 11 includes a plurality of keys for entering numbers, characters, symbols or the like, a sensor for recognizing a pressed key and a transmission circuit for transmitting a signal indicating a recognized key to the CPU 20.

The display device 12 displays a screen for giving the user a message or an instruction, a screen for the user to enter setting contents or process contents and a screen for indicating an image formed by the image forming device 1 and a result of the process. In this embodiment, a touch panel is used as the display device 12. Therefore, the display device 12 has a function of detecting a position on the touch panel where the user's finger touched and sending a signal of the detection result to the CPU 20.

In this way, the operational device 11 and the display device 12 work as a user interface for the user to operate the image forming device 1 directly. Note that an application program and a driver for giving instructions to the image forming device 1 are installed in the personal computer 31. Therefore, the user can operate the image forming device 1 also from a remote place by using the personal computer 31.

The scanner device 13 reads images including photographs, characters, pictures and charts on an original optically and generates digital image data (i.e., density data indicating density of RGB or black, here). The obtained image data are used by the printer device 14 for printing. Alternatively, the image data are converted into a file of a format such as TIFF (Tagged Image File Format) or PDF (Portable Document Format) and are stored in the data memory portion 23 or sent to the personal computer 31. Alternatively, the image data are converted into FAX data and are sent to the FAX terminal 32. The document feeder 17 is disposed at the upper portion of a main body of the image forming device 1 and is used for feeding one or more sheets of original to the scanner device 13 sequentially.

The printer device 14 prints an image read by the scanner device 13, an image of image data sent from the personal computer 31, an image of FAX data sent from the FAX terminal 32 on a record sheet such as paper or film. The paper feeding device 18 is disposed at the lower portion of the main body of the image forming device 1 and is used for supplying record sheets suitable for the image to be printed to the printer device 14. The record sheet on which the image is printed by the printer device 14, i.e., a printed matter is ejected into the tray 19.

The communication interface 16 includes a transmission portion and a reception portion, and is used for sending or receiving data to/from the personal computer 31 or the FAX terminal 32. As the communication interface 16, an NIC (Network Interface Card), a modem, a TA (Terminal Adapter), or the like can be used.

The hard disk drive 23H includes personal boxes each of which is assigned to each user as a storage area for storing each user's data as a file 6 as shown in FIG. 3. The personal box corresponds to a “directory” or “folder” in a personal computer or a workstation. Hereinafter this personal box is referred to as a “box 5”. The box 5 is associated with a box name for being discriminated from other boxes 5. In this embodiment, a user name of the user who is an owner of the box is used as the box name.

The user can store the file 6 in the box 5 by file transmission from the personal computer 31. Alternatively, the memory card 91 storing the file 6 may be set to the slot of the card reader and writer 23R and file copy may be executed for storing the file in the box 5. Other than that, the file 6 can be stored in the box 5 in the following case.

For example, when the user makes an instruction to copy an original set to the document feeder 17, the image forming device 1 converts image data of the image read from the original into the file 6 and stores the same in the box 5 of the user. Similarly, when an instruction to send image data of an image of an original set to the document feeder 17 to the personal computer 31 is made, the image data of the read image is converted into the file 6, which is stored in the box 5 of the user. When the personal computer 31 of the user issues an instruction to print a document (network printing), image data of the document sent from the personal computer 31 are stored as the file 6 in the box 5 of the user. When FAX data are transmitted from the FAX terminal 32, the FAX data are stored as the file 6 in the box 5 of the user who is a receiver. When an instruction to transmit an image of an original set to the document feeder 17 to the FAX terminal 32 is made, the image data of the read image are converted into the file 6, which is stored in the box 5 of the user.

The file 6 stored in the box 5 includes attribution information 6a and real image data 6b as shown in FIG. 4. The attribution information 6a indicates attribution of the file 6. The real image data 6b are data of contents (images, texts, charts or the like) of pages constituting the document of the file 6.

The “file name” of the attribution information 6a is identification information for discriminating the file 6 from other files 6 stored in the same box 5. Therefore, plural files 6 having the same file name cannot be stored in the same box 5, but it is possible to store them in different boxes 5. The “file attribution” is information for classifying contents of the document of the file 6, and the user can determine it for his or her convenience.

The “job attribution” indicates which type of process the file 6 is used to perform. Namely, a value of the job attribution is determined in accordance with which instruction the user made and how the file 6 was stored in the box 5.

In the example shown in FIG. 4, the job attribution indicates a value of “copy”. This means that the file 6 is a file for copying an original and was generated by file conversion of image data of an image read from the original in accordance with the copy instruction by the user and was stored in the box 5.

Furthermore, the job attribution may indicate a value such as “scan”, “print”, “FAX transmission”, or “FAX reception”. The value “scan” means that the file 6 is a file for transmitting an image of a scanned original to the personal computer 31 and was generated by file conversion of image data of an image read from the original in accordance with the user's scan instruction and was stored in the box 5. The value “print” means that the file 6 is a file for printing an image of a document prepared in the personal computer 31 and was obtained from the personal computer 31 in accordance with the user's print instruction and was stored in the box 5. The value “FAX transmission” means that the file 6 is a file for transmitting an image of a scanned original to the FAX terminal 32 and was generated by file conversion of image data of an image read from the original in accordance with the user's FAX transmission instruction into a FAX format and was stored in the box 5. The “FAX reception” means that the file 6 is a file for printing an image received from the FAX terminal 32 and was generated by file conversion of FAX data of the received image and was stored in the box 5.

A “job mode” of the attribution information 6a indicates which condition is to be used for performing the process indicated in the “job attribution”. In the example shown in FIG. 4, it means that the copy process should be performed in the conditions such that a finish of the printed matter is “with staples”, a print on a record sheet is “single sided print”, and a magnification is “1”. Furthermore, it is possible to set various conditions including color or monochrome print, a density, a finish with punch holes, the number of printed copies and a destination of transmission as the “job mode”.

The “image page information” of the attribution information 6a indicates attribution of the real image data 6b. For example, it indicates attribution about a print size and a print color of the page of the real image data 6b.

Note that the above-mentioned values are not set in the job attribution and the job mode of the file 6 that was simply transmitted from the personal computer 31 or duplicated from the memory card 91.

Furthermore, the hard disk drive 23H stores a user information database DB1 and a job history database DB2.

The user information database DB1 stores information about users who use the image forming device 1 as shown in FIG. 5. A “user name” is identification information for identifying each user. This user name is used when a user logs in the image forming device 1. A “password” is information for user authentication (user confirmation) when a user logs in.

The job history database DB2 stores information about processes (jobs) that were performed by the image forming device 1 and processes that could not be performed by the image forming device 1 (namely, that failed) as shown in FIG. 6. The “user name” indicates a user name of the user who made the instruction of the process. However, in the case of a process of FAX reception, it indicates a user name of a user who is a receiver. A “job type” indicates a type of the completed process or the failed process. A “used file” indicates a file name of the file 6 of the data that were used in the process. A “completion date” indicates a date and time when the process is completed. A “result” indicates whether the process was completed successfully or failed.

With reference to FIG. 2 again, the ROM 22 stores a program and data for realizing basic functions of the image forming device 1 including a reading (scanning) function of an image, a copy function of an original, a sending and receiving function of FAX data, a network printing function and a document server function (a box function). Furthermore, it stores a program and data for realizing functions of a process execution control portion 101, a user discrimination portion 102, a related file extraction portion 103 and a group process reception portion 104 as shown in FIG. 7. A part or the whole of the program or the data may be installed in the data memory portion 23. In this case, the program or the data installed in the data memory portion 23 may be loaded into the RAM 21 if necessary. Alternatively, a part or the whole of these functions may be realized by a processor (a circuit).

The RAM 21 stores temporarily data received from the personal computer 31 or the FAX terminal 32, data to be sent to the personal computer 31 or to the FAX terminal 32 and data generated by the scanner device 13. A nonvolatile RAM may be used as the RAM 21.

In addition, the RAM 21 stores an active job database DB3. This active job database DB3 stores information about processes (jobs) waiting for execution as shown in FIG. 8. Namely, the active job database DB3 is information indicating a queue. As a general rule, a job positioned in the upper line is executed first.

The “user name” indicates a user name of a user who made the request for the job. The “job type” indicates a type of the job. The “state” indicates a present state of the job. The “state” of a job that can be executed promptly when it becomes the turn of the job stores a value of “waiting”. A value of “pending” is stored in the “state” of the job whose process is temporarily suspended. In this case, even if it becomes this job's turn, execution is skipped until the pending state is canceled.

The CPU 20 executes the program stored in the ROM 22 or the program loaded into the RAM 21 and controls the entire of the image forming device 1.

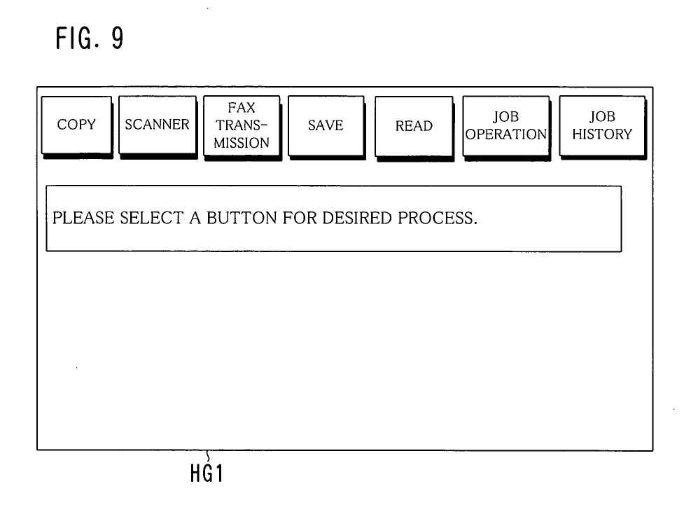

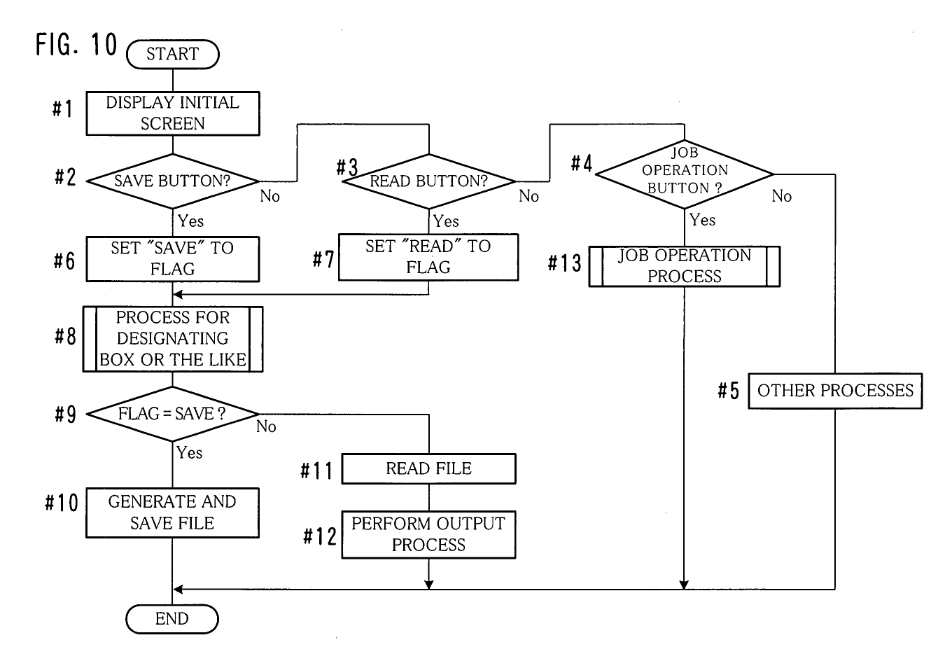

FIG. 9 shows an example of an initial menu screen HG1, and FIG. 10 is a flowchart showing an example of a flow of a general process of the image forming device 1.

Next, functions of portions and contents of processes in the image forming device 1 shown in FIG. 7 will be described with reference to flowcharts and others. Note that a program for realizing processes of the flowcharts is stored in the ROM 22, the hard disk drive 23H or the like, and the CPU 20 controls portions of the image forming device 1 in accordance with the program so that each operation of the flowchart is executed.

The display device 12 of the image forming device 1 displays the initial menu screen HG1 as shown in FIG. 9 when nobody is operating the image forming device 1 directly (#1 in FIG. 10). A user who is going to let the image forming device 1 perform a process presses and selects a button corresponding to the desired process on the initial menu screen HG1.

Then, the process execution control portion 101 shown in FIG. 7 starts to control each portion of the image forming device 1 so that a process corresponding to the selected button is performed.

If the user selects a “copy” button, a “scanner” button, a “FAX transmission” button or a “job history” button (No in all the Steps #2-#4), the process execution control portion 101 controls each portion of the image forming device 1 as follows so that a copy process, a scan (image read) process, a FAX transmission process or a display process of the job history screen is performed (#5).

If the “copy” button is selected, the display device 12 is controlled to display a screen for designating conditions including the number of copies, a scaling ratio, a density, a color print or a monochrome print, a double sided print or not and a finish (with or without staples and punch holes). A job for performing the copy in accordance with the condition designated by the user is generated and is registered in the active job database DB3 shown in FIG. 8. Then, as the job's turn comes, a scanner device 13 or the like is controlled to read an image of an original set to the document feeder 17 in accordance with the condition designated by the user, and a printer device 14 is controlled so that the image is printed on recording sheets.

If the “scanner” button is selected, the display device 12 is controlled to display a screen for designating conditions including image quality for reading, a density for reading, whether or not an original is a double sided original, a format for converting the read image data into a file (TIFF, PDF or the like) and a destination of transmission of the converted file. Then, similarly to the above case of copy, a job is registered in the active job database DB3. When it comes a turn of the job, the scanner device 13 or the like is controlled so that an image of an original set to the document feeder 17 is read so as to generate an image file in accordance with the condition designated by the user, and the communication interface 16 is controlled to send the file to the designated destination.

If the “FAX transmission” button is selected, the display device 12 is controlled to display a screen for designating conditions including a telephone number of a transmission destination, image quality for reading, a density for reading and whether or not an original is a double sided original. Then, similarly to the above case of copy or the like, when it comes a turn of the job, the scanner device 13 or the like is controlled so as to read an image of an original set to the document feeder 17 and to generate FAX data in accordance with the condition designated by the user, and the communication interface 16 is controlled so as to send the FAX data.

If the “job history” button is selected, the display device 12 is controlled to display a list of jobs that were performed and jobs that failed in accordance with information stored in the job history database DB2 shown in FIG. 6.

Note that the user can let the image forming device 1 perform the print process by remote control using the personal computer 31. For example, the user opens an image file to be printed and enters a predetermined command after designating a print condition. Then, data for printing the image are transmitted from the personal computer 31 to the image forming device 1 together with information indicating the print condition. When the image forming device 1 receives these data, the job of the print process is registered in the active job database DB3, and the print process is performed by the printer device 14 or the like when it comes the job's turn similarly to the case of copy described above.

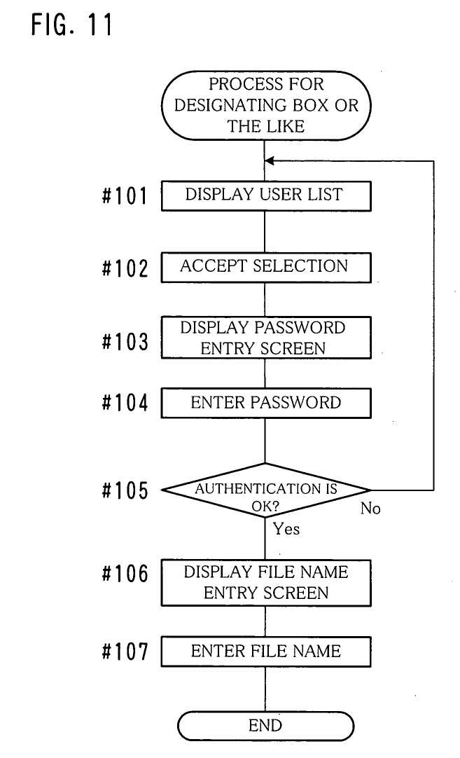

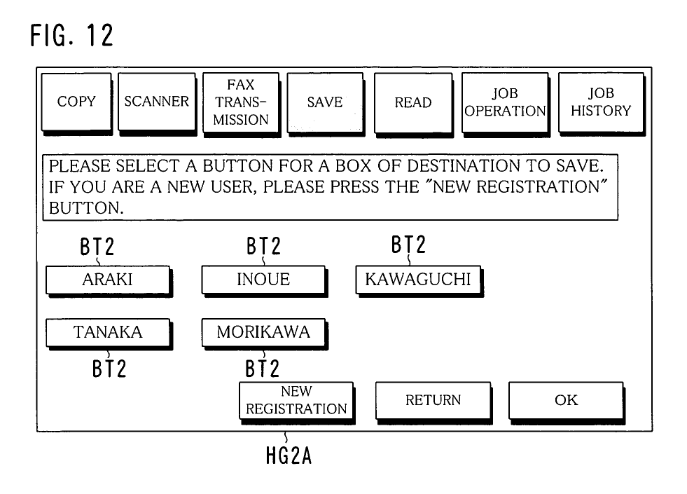

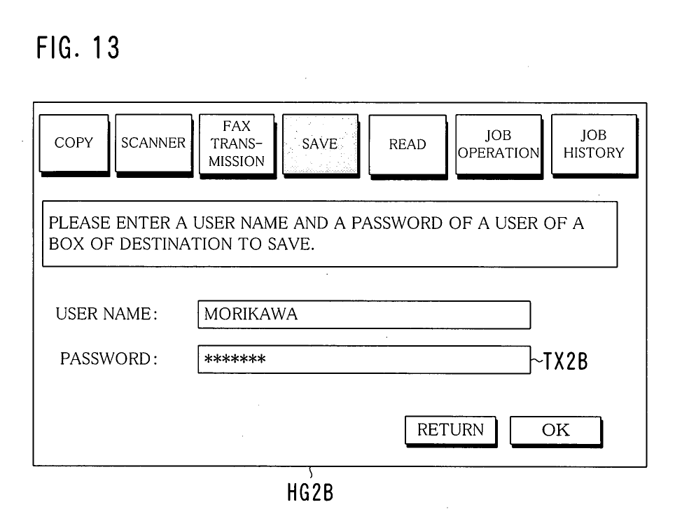

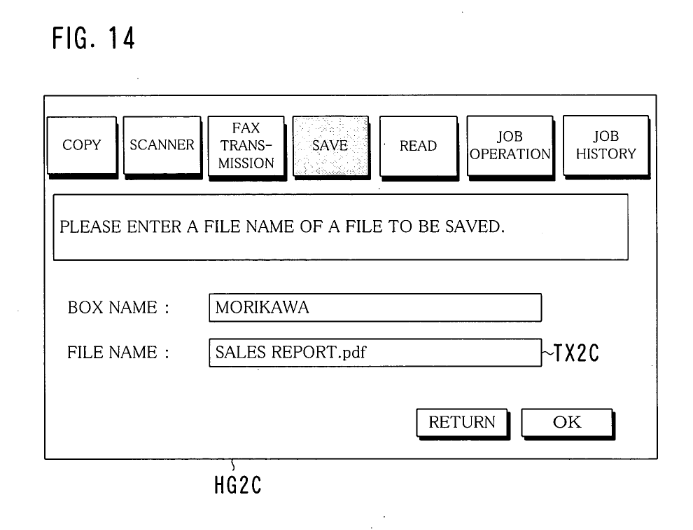

FIG. 11 is a flowchart showing an example of a flow of a process for designating a box or the like, FIG. 12 shows an example of a user selection screen HG2A, FIG. 13 shows an example of a password input screen HG2B, and FIG. 14 shows an example of a file name input screen HG2C.

With reference to FIG. 10 again, if a “save” button is pressed when the user selects any one of the “copy” button, the “scanner” button and the “FAX transmission” button on the initial menu screen HG1 (Yes in #2), the process execution control portion 101 controls each portion as follows so that a file 6 for performing a process corresponding to the selected button is generated and is stored in the box 5.

A value “save” is set to a process flag for indicating a state (a type) of the process to be performed (#6). A process for designating a file name of the file 6 to be saved and a box 5 as a destination to save is performed by the procedure shown in FIG. 11 (#8).

Namely, the process execution control portion 101 controls the display device 12 to display the user selection screen HG2A shown in FIG. 12 for the user (#101). Here, the user finds a user selection button BT2 indicating his or her user name and presses it to select the same. When the process execution control portion 101 receives the selected user selection button BT2 (#102), the password input screen HG2B shown in FIG. 13 is displayed (#103). Here, the user operates keys of the operational device 11 so as to enter his or her password in a text box TX2B and presses an “OK” button. Note that FIG. 13 shows an example of the password input screen HG2B when a “MORIKAWA” button is pressed on the user selection screen HG2A shown in FIG. 12.

When the entered password is accepted (#104), the process execution control portion 101 requests the user discrimination portion 102 to perform the user authentication process. The user discrimination portion 102 retrieves a password of the user selected on the user selection screen HG2A from the user information database DB1 (see FIG. 5) and compares the password with the accepted password so as to decide whether or not the user operating the image forming device 1 is a correct user (#105).

If it is decided to be the correct user (Yes in #105), the log-in process of the image forming device 1 for the user is completed, and the file name input screen HG2C shown in FIG. 14 is displayed (#106). Here, the user determines a file name of the file to be saved, enters the file name in a text box TX2C, and presses the “OK” button. The process execution control portion 101 accepts the entered file name (#107). If it was not decided to be a correct user because the passwords are not identical to each other, (No in #105), an error message is displayed for inviting the user to select a user name and enter the password again.

Thus, a storage place and a file name of the file 6 to be saved are designated. Namely, the box 5 corresponding to the user name accepted in Step #102 becomes the storage place of the file 6, and the file name accepted in Step #107 becomes the file name of the file 6.

Note that if a “return” button is pressed on each of the above-mentioned screens shown in FIGS. 12, 13 and 14 or on each of screens described below, the screen of the initial menu screen HG1 is displayed again. Then, the user can operate the selection of each item or the like from the beginning.

With reference to FIG. 10 again, the process execution control portion 101 controls each portion of the image forming device 1 so as to generate the file 6 for performing the process selected on the initial menu screen HG1, to attach the file name designated in Step #8 to the file 6, and to store the file in the box 5 designated in Step #8 (#10). The procedure for generating the file 6 is almost the same as a part of the procedure in the process described in Step #5.

For example, when the “copy” button is selected, a screen for designating the conditions including the number of copies and file attribution is displayed. An image of an original is read in accordance with contents designated by the user. Data of the image of the read original are converted into the real image data 6b of a predetermined format (see FIG. 4), and the attribution information 6a is generated in accordance with the designated contents. Then, the attribution information 6a and the real image data 6b are compiled into one group so as to generate the file 6. If the “scanner” button is selected, a screen for designating conditions including the image quality for reading and the file attribution is displayed. An image of an original is read in accordance with the designated contents. Then, similarly to the case where the “copy” button is selected, the attribution information 6a and the real image data 6b of the image of the read original are generated and compiled into one group to generate the file 6. If the “FAX transmission” button is selected, a screen for designating conditions including a telephone number of a transmission destination and file attribution is displayed. An image of an original is read so as to generate the real image data 6b for FAX transmission in accordance with the designated contents. Then, the attribution information 6a and the real image data 6b are generated, and the file 6 is generated.

Note that it is possible not only to generate the file 6 for performing the process corresponding to the button selected from the initial menu screen HG1 and save the file 6 in the box 5, but also to perform the process promptly. Alternatively, it is possible not to perform the process here, but to perform the process later when a user makes the instruction. It is preferable that a user can select whether or not to perform the process promptly.

In addition, the user can store the file 6 for printing the image generated by the personal computer 31 by using the image forming device 1 in his or her box 5. In this case, the user selects an option corresponding to the “save” button on the initial menu screen HG1 when entering a command of the print process. Then, the image forming device 1 converts the print data received from the personal computer 31 into a file so as to generate the file 6, which is saved in the box 5 of the user.

When the user finishes using the image forming device 1, the user performs a predetermined operation to log out of the image forming device 1. In addition, it is possible to perform the log out forcibly after a period of no operation has continued over a predetermined time.

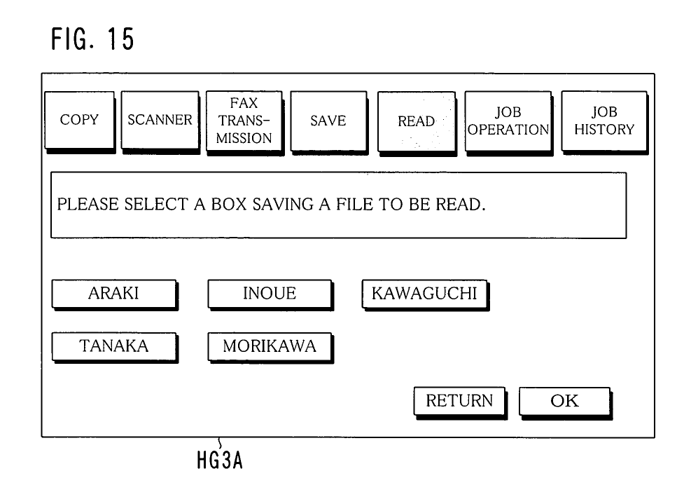

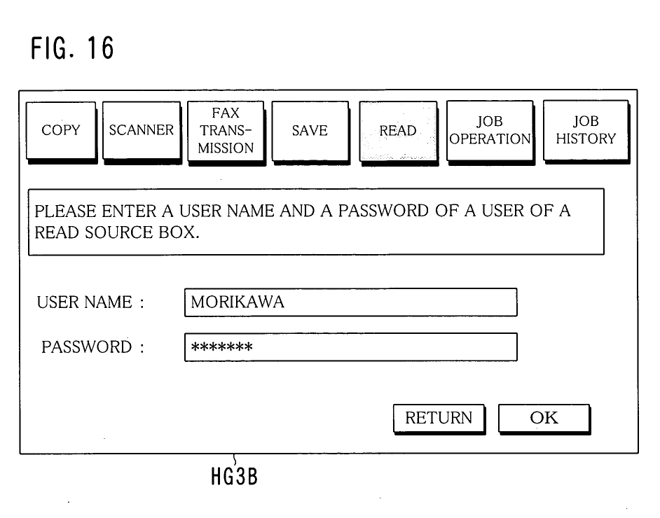

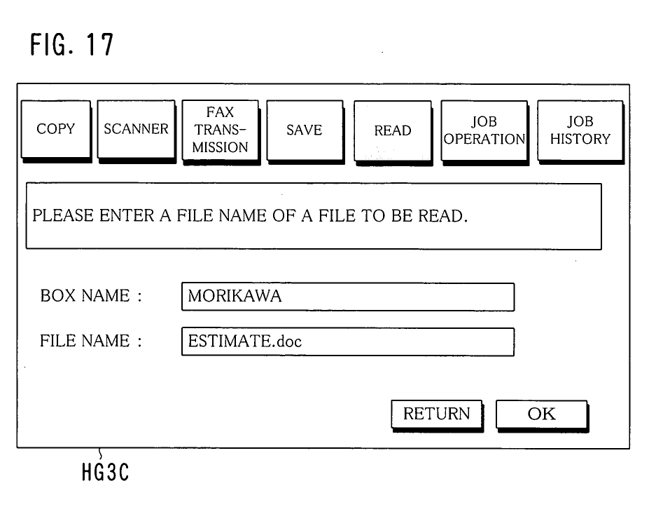

FIG. 15 shows an example of a user selection screen HG3A, FIG. 16 shows an example of a password input screen HG3B, and FIG. 17 shows an example of a file name input screen HG3C.

The user can read the file 6 that was stored in the box 5 by the process in Steps #6, #8, #9 and #10 shown in FIG. 10 and let the image forming device 1 perform the desired process. In this case, the image forming device 1 performs the process by the following procedure.

When the user selects a “read” button on the initial menu screen HG1 shown in FIG. 9 (No in #2, Yes in #3), the process execution control portion 101 sets a value “read” to the process flag (#7). The file 6 to be read is designated (#8). The procedure of designation is basically the same as the case described above where the storage place and the file name are designated in the process for saving the file 6, which is shown in FIG. 11. However, in Steps #101, #103 and #106 shown in FIG. 11, the user selection screen HG2A shown in FIG. 12, the password input screen HG2B shown in FIG. 13 and the file name input screen HG2C shown in FIG. 14 are replaced with the user selection screen HG3A shown in FIG. 15, the password input screen HG3B shown in FIG. 16 and the file name input screen HG3C shown in FIG. 17, respectively.

The process execution control portion 101 controls each portion of the image forming device 1 so that the process is performed in accordance with the file 6 of the file name designated in Step #8 stored in the box 5 designated in Step #8.

Namely, the hard disk drive 23H is controlled so that the file 6 is read out of the box 5 first (#11). The job is registered in the queue of the active job database DB3 (see FIG. 8) in accordance with the attribution information 6a of the file 6. Thus, reservation of execution of the job is performed, and the job becomes the waiting state. When it comes the job's turn, the printer device 14 and the communication interface 16 or the like are controlled so that a process for producing real image data 6b (copy, print, file transmission, FAX transmission or the like) is performed under the condition indicated in the attribution information 6a (#12).

For example, if a job type of the job is “copy” or “print” and the attribution information 6a indicates the job mode (the process condition) “with staples, double sided”, the printer device 14 or the like is controlled so that the document of the real image data 6b of the file 6 is printed by double sided printing and the printed matter is stapled. If the job type is “scan” and the attribution information 6a indicates the job mode “transmission destination=MORIKAWA@ . . . .com”, the communication interface 16 or the like is controlled so that the file 6 is attached to electronic mail and the electronic mail is sent to the electronic mail address.

Note that a program for sending screen data of a screen that is equal to each screen for being displayed on the display device 12 to the personal computer 31 and a program for receiving information entered in the screen from the personal computer 31 are installed in the image forming device 1. Thus, the user can read the file 6 stored in the box 5 by remote control from his or her personal computer 31 so that the image forming device 1 performs the desired process. In addition, the user can also perform the operation for a group process described below from the personal computer 31.

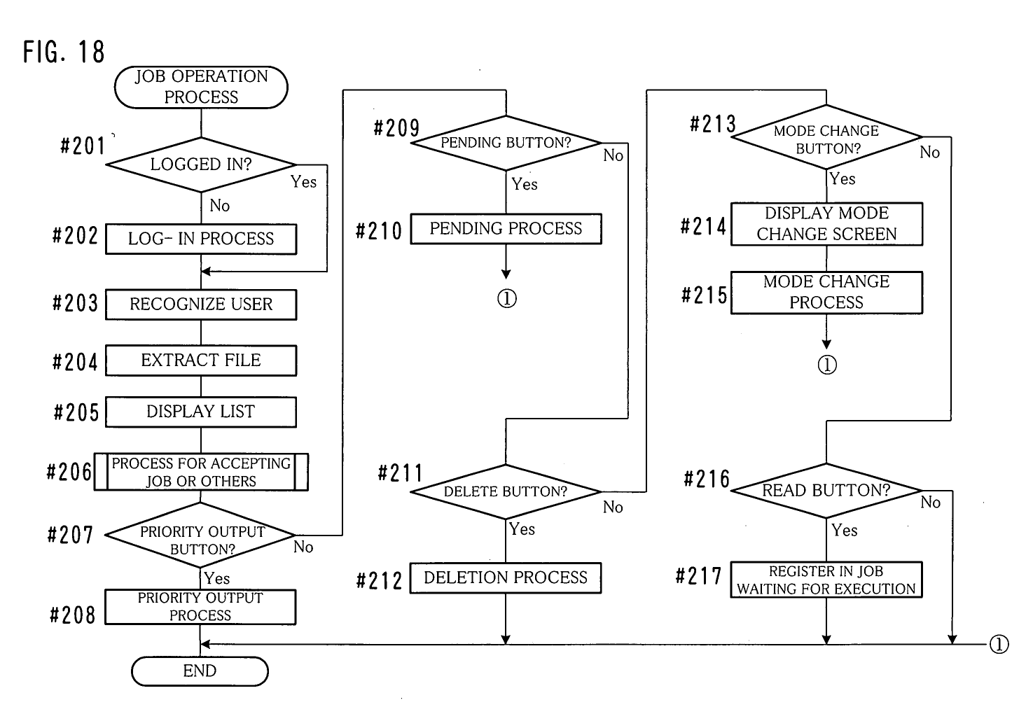

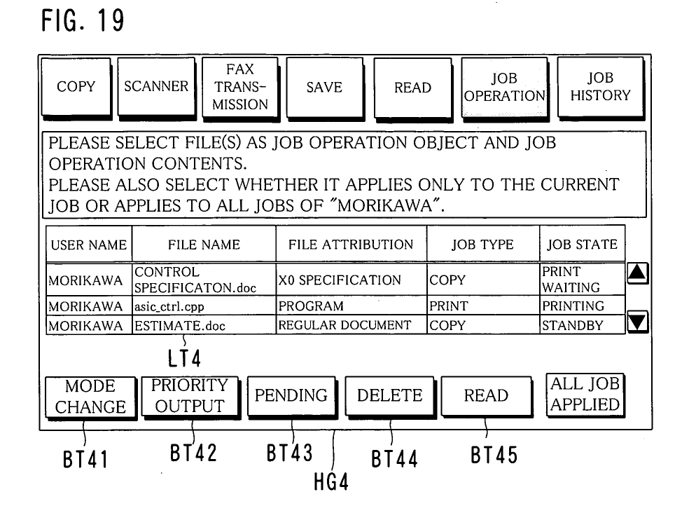

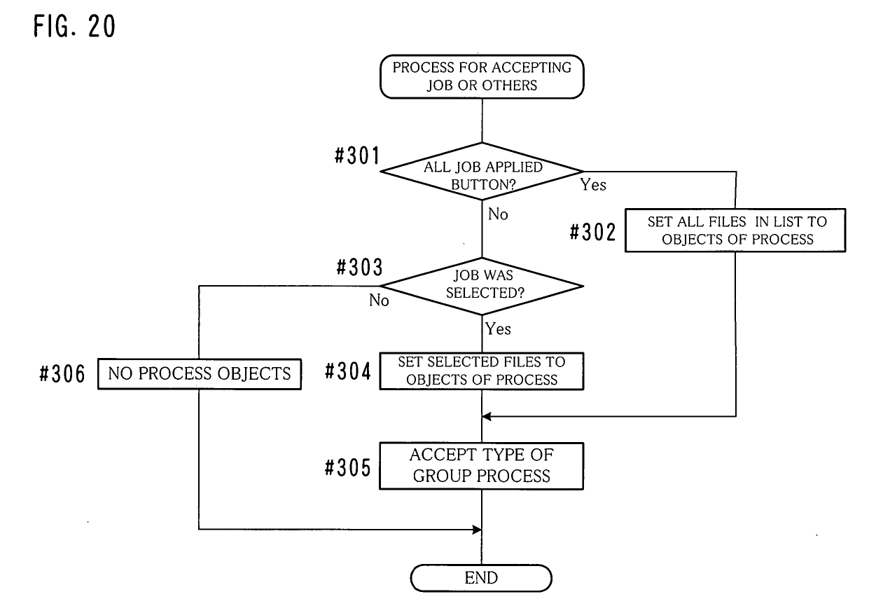

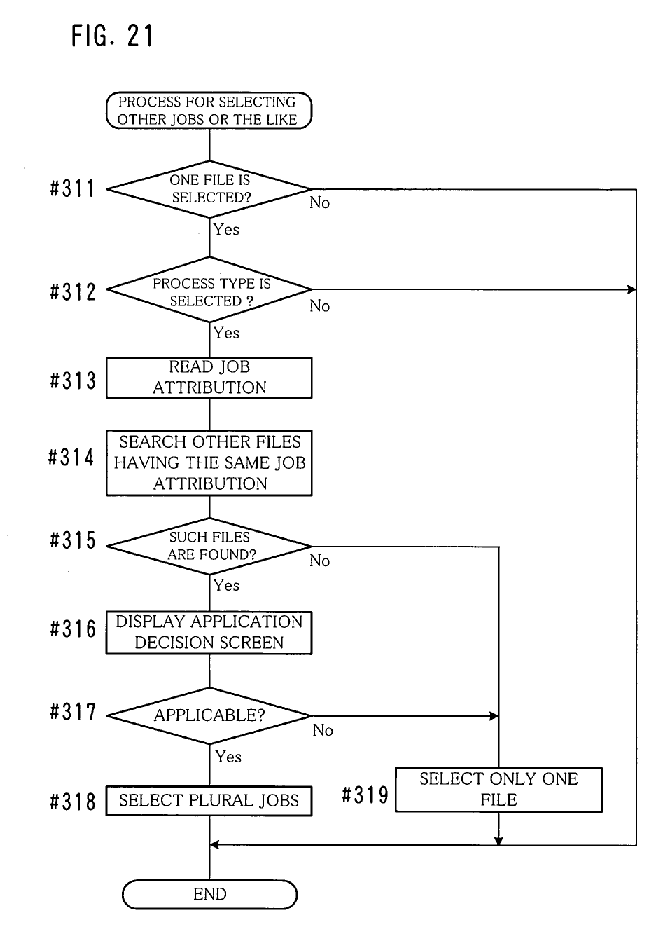

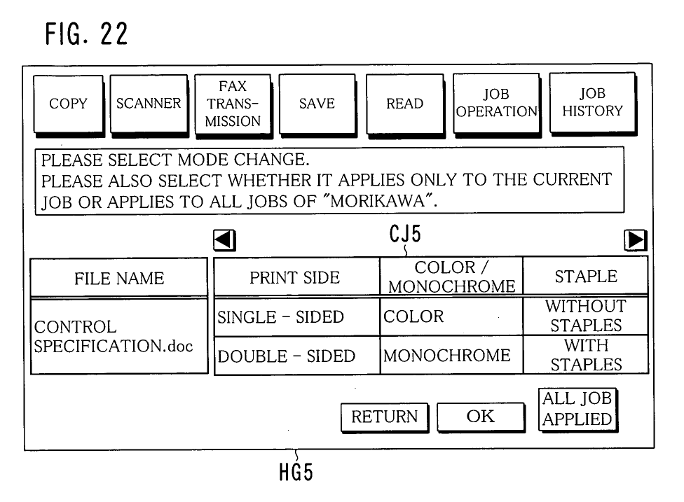

FIG. 18 is a flowchart showing an example of a flow of a job operation process, FIG. 19 shows an example of a process object selection screen HG4, FIGS. 20 and 21 are flowcharts showing an example of a flow of a process for accepting a job or the like, and FIG. 22 shows an example of a change designation screen HG5.

The user can let the image forming device 1 perform processes for plural files 6 stored in the box 5 as one group. Furthermore, the image forming device 1 of the present invention has a function for the user to select easily plural files 6 to be processed as one group. Hereinafter, such a batch process is referred to as a “group process”.

If the user wants to use this function, the user selects a “job operation” button on the initial menu screen HG1 (see FIG. 9) (No in #2, No in #3, Yes in #4 shown in FIG. 10). Then, the image forming device 1 performs the process for realizing the function in the procedure as shown in FIG. 18 (#13).

The user discrimination portion 102 decides which user selected the “job operation” button. More specifically, if there is a user who is currently operating the operational device 11 or the display device 12 to log in the image forming device 1 (Yes in #201), it is decided that the user is a “user who selected the “job operation” button” (#203).

Otherwise (No in #201), the user who has just selected the “job operation” button is invited to log in the image forming device 1 by the following procedure (#202). A screen for entering a user name and a password is displayed on the display device 12 so as to request the user to log in the image forming device 1. The password corresponding to the entered user name is retrieved from the user information database DB1 shown in FIG. 5 and is compared with the entered password. If they are identical to each other and the user is authenticated, the log-in of the user to the image forming device 1 is permitted. Then, it is decided that the user who has logged in is the user who selected the “job operation” button (#203).

The related file extraction portion 103 searches and extracts a file 6 having connection with the user decided in Step #203 from the hard disk drive 23H (#204). In this embodiment, a file stored in a box 5 having the same box name as the user name of the user is extracted as the file 6 having connection with the user.

The process execution control portion 101 controls the display device 12 to display a list of information about the extracted file 6. Then, the display device 12 displays the process object selection screen HG4 including a list table LT4 of the files 6 having connection with the user as shown in FIG. 19 (#205).

In the list table LT4, the “job state” indicates the current state of the process (the job) in accordance with the file 6 indicated in the line. For example, the “waiting print” means that the print job of the contents of the file 6 corresponding to the line is registered in the active job database DB3 (see FIG. 8) and is waiting its turn for execution. The “printing” means that the print process is being performed at present based on the file 6 corresponding to the line. The “standby” means that no process having connection with the file 6 corresponding to the line is being performed at present. The “pending” means that though the process (the job) based on the file 6 corresponding to the line is registered in the active job database DB3, execution thereof is postponed until a restart instruction is issued.

If the number of extracted files 6 is large, all of them may not be displayed in a display area of the list table LT4 at one time. In this case, the user may operate two scroll buttons disposed at the right side of the list table LT4 so as to scroll the list table LT4 vertically and confirm the information about all the extracted files 6.

Here, the user operates the list table LT4 or the button on the process object selection screen HG4 so as to designate a file 6 to be processed as a group and a type of the group process. If all the files 6 in the list table LT4 should be processed, an “all job applied” button is pressed. If some files 6 should be processed, lines indicating file names of the files 6 are designated by pressing one line at a time. Then, a type of the group process to be performed for the designated files 6 is designated by selecting one of group process selection buttons BT41-BT45. Thus, the instruction of the group process is issued to the image forming device 1.

Then, the group process reception portion 104 shown in FIG. 7 performs a process for accepting an instruction from a user as shown in FIG. 20, for example (#206 shown in FIG. 18). If the “all job applied” button is pressed (Yes in #301 shown in FIG. 20), all the files 6 extracted in Step #204 shown in FIG. 18 are accepted as objects of the group process (#302). If one or more lines in the list table LT4 are selected (No in #301, Yes in #303), files 6 corresponding to the selected lines are accepted as objects of the group process (#304). Then, the group processes corresponding to the selected group process selection buttons BT41-BT45 are accepted as instructions from the user (#305).

If neither the “all job applied” button nor any line of the list table LT4 is pressed (No in #303), an object of the process shall not be designated here (#306).

Alternatively, the group process reception portion 104 may perform the process for accepting an instruction from the user as shown in FIG. 21 in Step #206 shown in FIG. 18.

If the user selects one of the files 6 in the list table LT4 (Yes in #311 shown in FIG. 21) and presses one of the group process selection buttons BT41-BT45 (Yes in #312), the group process reception portion 104 reads the job attribution (see FIG. 4) of the attribution information 6a in the file 6 and checks the value (#313).

Another file 6 having the same value of the job attribution is searched and extracted from the files 6 that were extracted by the related file extraction portion 103 (files 6 stored in the box 5 of the user who is operating the image forming device 1, in this embodiment) (#314).

If such files 6 are found (Yes in #315), a screen for inquiring whether or not these files 6 should be objects of the group process is displayed (#316). Then, if a decision that the files 6 should be objects of the group process is entered (Yes in #317), the file 6 selected in Step #311 and the file 6 searched in Step #314 are decided to be objects of the group process (#318). If the search was not performed (No in #315) or a decision that the searched files 6 should not be objects of the group process is entered (No in #317), only the file 6 selected in #311 is decided to be the object of the process (#319).

The process execution control portion 101 shown in FIG. 7 controls each portion of the image forming device 1 as follows in accordance with contents of the instruction accepted by the group process reception portion 104.

If the instruction of the group process corresponding to the group process selection button BT42 is accepted (Yes in #207 shown in FIG. 18), the job of the file 6 that is an object of the process and accepted in Step #206 is searched from the active job database DB3 (the queue) shown in FIG. 8, and this job is moved to the head position of the queue (#208). Namely, the control is performed so that a job of the file 6 that is designated by the user as an object of the process and is in the “waiting” state is given a higher priority for execution. Note that if the job of the file 6 designated as the object of the process is not registered in the queue (namely, if the job state of the designated file 6 is “standby” (see FIG. 19)), it is possible to generate the job data in accordance with the file 6 and to register the same at a position near to the head in the queue. Alternatively, it is possible to remove the file 6 from objects of the group process as the selection of the file 6 is invalid or to prevent the file 6 from being selected on the process object selection screen HG4 shown in FIG. 19.

If the instruction of the group process corresponding to the group process selection button BT43 is accepted (Yes in #209), the control is performed so that the job of the file 6 that was accepted in Step #206 and is the object of the process is searched from the queue, and the execution of the job is temporarily stopped, i.e., becomes pending (#210). Note that if the job of the file 6 designated as the object of the process is not registered in the queue, control can be performed so as to generate the job data in accordance with the file 6 and to register the same at the last position in the queue and set the execution of the job to pending. Alternatively, in the same manner as the case of the output process in higher priority in Step #208, it is possible to remove such a file 6 from objects of the group process or to disable the selection of such a file 6.

If the instruction of the group process corresponding to the group process selection button BT44 is accepted (Yes in #211), the job of the file 6 accepted in Step #206 as the object of the process is erased from the queue (#212).

If the instruction of the group process corresponding to the group process selection button BT41 is accepted (Yes in #213), the change designation screen HG5 as shown in FIG. 22 is displayed on the display device 12 (#214). Here, the user can operate a condition change menu CJ5 for changing execution conditions of the file 6 that is the object of the group process at one time. For example, if the user wants to change the print conditions to “double sided print, color print and finish with staples”, the user presses “double sided”, “color” and “with staple” buttons one by one from the left column in the condition change menu CJ5. Then, the user presses the “OK” button.

Note that if the user wants to change the process condition of all files 6 having connection with the user, the user presses the “all job applied” button and presses the “OK” button. If the user wants to change other process condition that is not displayed on the screen, the user may operate the scroll button that is disposed at the upper portion of the condition change menu CJ5.

When the “OK” button is pressed, the group process reception portion 104 shown in FIG. 7 accepts contents designated on the change designation screen HG5, and the process execution control portion 101 controls the hard disk drive 23H or the like so as to change the attribution information 6a (see FIG. 4) of the file 6 that is the object of the group process in accordance with the contents (#215).

However, there will be the case where the attribution information 6a cannot be changed as the user has designated. For example, if “with staples” was designated in the condition change menu CJ5 but the document of the file 6 to be changed has pages of different paper sizes, the finish with staples cannot be applied. Alternatively, if “color” was designated but the image of the file 6 to be changed is only monochrome, the color output cannot be applied. If the condition cannot be changed in accordance with the user's designation as described above, the file 6 is erased from the objects of the group process. Alternatively, only applicable conditions are changed. It is also possible to prevent the file 6 from being selected, or to set so that the file 6 cannot be selected when the “all job applied” button is pressed.

If the instruction of the group process corresponding to the group process selection button BT45 is accepted (Yes in #216), a new job is generated in accordance with the file 6 that is the object of the group process and the job is registered at the end of the active job database DB3 (#217). Namely, a job for performing the process of the “job attribution” under the output condition of the “job mode” of the attribution information 6a for the image of each of the real image data 6b that constitute the file 6. For example, if the file 6 has the structure as shown in FIG. 4, a job is generated for printing the image of each of the real image data 6b on one side of recording sheets at the magnification of one, and for stapling the recording sheets. If the job attribution is “scan”, a job is generated for sending the file 6 (or the real image data 6b included in the file 6) to the transmission destination indicated in the attribution information 6a.

According to this embodiment, when performing a group process for plural files 6 stored in the image forming device 1, the files 6 to be processed can be selected more readily than the conventional method. For example, a state such as an order or timings of execution of print job, copy job or the like in accordance with plural files 6 can be readily changed.

Furthermore, only files 6 having connection with the user who conducts the operation are exhibited as options, bad influence on data of other users can be prevented.

In this embodiment, the related file extraction portion 103 shown in FIG. 7 extracts, as files 6 having connection with a user who operates the image forming device 1, files 6 stored in the box 5 having a user name of the user (i.e., that are assigned to the user). However, it is possible to extract files 6 having other type of connection.

For example, if the image forming device 1 is disposed at a company or an office and the box 5 is allocated to each of divisions (groups), it is possible to extract not only files 6 stored in the box 5 of the user who operates the image forming device 1 but also files 6 stored in the box 5 of the division to which the user belongs. If a field for recording an author is provided to the attribution information 6a (see FIG. 4) of the file 6, it is possible to extract files 6 having the user name in the field. If a field for recording an access right in the attribution information 6a of the file 6, it is possible to extract files 6 for which the user operating the image forming device 1 has a predetermined access right (for example, a change right, a full access right or the like). The connection type of the file 6 to be extracted may be preset in the image forming device 1 or may be selected by the user.

Though five types of group processes are prepared (see FIG. 19) in this embodiment, it is possible to prepare other types of group processes. For example, it is possible to erase plural files 6 selected by the user from the box 5 as a group. Further, it is possible to change the access right for plural files 6 selected by the user as a group. It is possible to advance or postpone an execution start time of jobs of plural files 6 selected by the user as a group by a predetermined time.

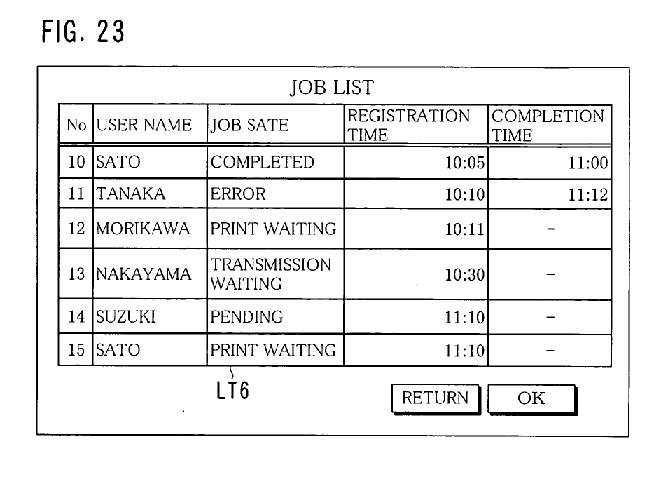

FIG. 23 shows an example of a job list screen HG6. In this embodiment, a list of files 6 having connection with the user who operates the image forming device 1 is displayed on the display device 12. However, it is possible to display a file 6 related to other user.

For example, the job list screen HG6 having a job list table LT6 as shown in FIG. 23 is displayed on the display device 12. The job list table LT6 indicates jobs whose output processes are completed, failed jobs, and jobs waiting for output. These jobs are based on the job history database DB2 and the active job database DB3 (see FIGS. 6 and 8).

When the user presses and selects a line corresponding to any one of the jobs, the related file extraction portion 103 selects and extracts files 6 having connection with the user who made the instruction of the job from files 6 stored in the hard disk drive 23H. Then, the process object selection screen HG4 including the list table LT4 indicating the extraction result is displayed as shown in FIG. 19. Note that it is possible to display the job list table LT6 of the job list screen HG6, the list table LT4 of the process object selection screen HG4, the buttons and the message on one screen.

The present invention can be applied not only to an MFP but also to a FAX terminal, a printer device or an image reading device. Alternatively, it can be applied to a server that is connected to a FAX modem, a printer device and an image reading device.

Furthermore, a structure of the whole or each portion of the file sharing system FS or the image forming device 1, contents of processes, the order of processes, the output condition, the structure of the attribution information 6a can be changed if necessary in accordance with the spirit of the present invention.

Furthermore, this embodiment includes the following inventions.

1. A data control device according to claim 1, wherein the data searching portion searches data stored in the storage area that is allocated to the user as the data having connection with the user.

2. A data control device according to claim 1, wherein the data searching portion searches data made by the user as the data having connection with the user.

3. A data control device according to claim 1, wherein the data searching portion searches data for which the user has a predetermined access right as the data having connection with the user.

4. A data control device according to claim 7, wherein the control portion controls each portion constituting the image output device so as to perform the process for the output data selected first by the user on the data list screen and data having the same attribution as the output data as the output data that satisfy a predetermined condition.

The present invention can be used suitably for improving usability of an image forming device such as an MFP.

While the presently preferred embodiments of the present invention have been shown and described, it will be understood that the present invention is not limited thereto, and that various changes and modifications may be made by those skilled in the art without departing from the scope of the invention as set forth in the appended claims.

What is claimed is:

1. A data control device comprising:
a data storage portion for storing data;
a data connection processing portion for performing a data connection process that is a process having connection with the data;
a user discrimination portion for discriminating a user who operates the data control device; and
a data searching portion for searching the data having connection with the user discriminated by the user discrimination portion from the data stored in the data storage portion, wherein
the data connection processing portion performs the data connection process for the plural searched data having connection with the user.

2. The data control device according to claim 1, further comprising a screen output portion for producing a data list screen for the user to select any one to be an object of the data connection process among the searched data having connection with the user, wherein
the data connection processing portion performs the data connection process for the plural data selected by the user on the data list screen.

3. The data control device according to claim 1, further comprising an input portion for letting the user enter an instruction to select all data having connection with the user, wherein
the data connection processing portion performs the data connection process for all the data having connection with the user when the instruction to select all the data is entered by the input portion.

4. An image output device, comprising:
an output portion for outputting an image, that includes at least one of a print portion for printing an image on a recording sheet and a data transmission portion for sending image data to another device;
a data storage portion for storing output data including image data of an image to be outputting by the output portion;
a user discrimination portion for discriminating a user who operates the image output device;
a data searching portion for searching the output data having connection with the user discriminated by the user discrimination portion from data stored in the data storage portion; and
a control portion for controlling each portion that constitutes the image output device so that a designated process is performed for the plural searched output data having connection with the user.

5. The image output device according to claim 4, further comprising a screen output portion for producing the data list screen for the user to select output data to be processed among the searched output data having connection with the user and a process designation screen for the user to designate a process to be performed for the output data selected by the user, wherein
the control portion controls each portion that constitutes the image output device so that a process designated by the user on the process designation screen is performed for the plural output data selected by the user on the data list screen.

6. The image output device according to claim 5, further comprising an input portion for letting the user enter an instruction to select all output data having connection with the user, wherein
the control portion controls each portion constituting the image output device so as to perform a process designated by the user on the process designation screen for all the output data having connection with the user if the instruction to select all the output data is entered.

7. The image output device according to claim 5, further comprising an input portion for letting the user enter an instruction to select all output data satisfying a predetermined condition from the output data having connection with the user, wherein
the control portion controls each portion constituting the image output device so as to perform a process designated by the user on the process designation screen for all the output data having connection with the user if the instruction to select all the output data satisfying the predetermined condition is entered.

8. The image output device according to claim 5, further comprising an execution order management portion for managing an execution order of output process of images that are scheduled to be executed by the output portion, wherein
the output data includes output condition data indicating an image output condition,
the output portion executes a process in accordance with the execution order managed by the execution order management portion,
the screen output portion outputs, as the process designation screen, a screen for the user to select and designate one of at least two processes selected from five processes including a first process for changing a condition of image output, a second process for raising a priority order of the image output, a third process for holding the image output temporarily, a fourth process for stopping the image output and a fifth process for reserving the image output, and
the control portion controls the data storage portion so that the output condition data of the output data selected by the user are changed if the user designated the first process in the data list screen, controls the execution order management portion so that an image output process of the output data selected by the user is executed with higher priority than other output process if the user designated the second process, controls the execution order management portion so that execution of the image output process of the output data selected by the user is held if the user designated the third process, controls the execution order management portion so that execution of the image output process of the output data selected by the user is stopped if the user designated the fourth process, and controls the execution order management portion so as to reserve execution of the image output of the output data selected by the user in accordance with the output condition indicated in the output condition data if the user designated the fifth process.

9. The image output device according to claim 8, wherein
both the print portion and the data transmission portion are provided as the output portion,
the output data include output method data that indicate which method should be used for outputting the image, and
the print portion prints the image on recording sheets in accordance with the image data and the output condition data of the output data if the output method data of the output data indicate that the output should be performed by printing on recording sheets, while the data transmission portion sends the image data of the output data to a transmission destination indicated in the output condition data if the output method data indicate that the output should be performed by sending data.

10. A control method in a data control device including a data storage portion for storing data and a data connection processing portion for executing a data connection process that is a process having connection with the data, the method comprising:
a first step for discriminating a user who operates the data control device;
a second step for searching the data having connection with the discriminated user from the data stored in the data storage portion; and
a third step for controlling the data connection processing portion so that the data connection process is executed for the plural searched data having connection with the user.

11. The control method according to claim 10, further comprising a fourth step for producing a list screen for the user to select data to be objects of the data connection process from the searched data having connection with the user, wherein
the third step includes controlling the data connection processing portion so that the data connection process is performed for the data selected on the list screen among the plural searched data having connection with the user.

12. A computer program product that is used for a computer including a data storage portion for storing data and a data connection processing portion for executing a data connection process that is a process having connection with the data, the computer program product makes the computer execute the process comprising the steps of:
discriminating a user who operates the data control device;
searching the data having connection with the discriminated user from the data stored in the data storage portion; and
controlling the data connection processing portion so that the data connection process is executed for the plural searched data having connection with the user.

13. The computer program product according to claim 12, the process further comprising the step of producing a list screen for the user to select data to be objects of the data connection process from the searched data having connection with the user, wherein
the controlling step includes controlling the data connection processing portion so that the data connection process is performed for the data selected on the list screen among the plural searched data having connection with the user.
